(19) United States
(12) Patent Application Publication
(10) Pub. No.: US 2004/0231711 A1
(43) Pub. Date: Nov. 25, 2004

(54) Spin chuck for wafer or LCD processing

(76) Inventors: Cheol-woo Park, Gyeonggi-do (KR); Yong-sun Ko, Gyeonggi-do (KR); In-Seak Hwang, Gyeonggi-do (KR); Byoung-moon Yoon, Gyeonggi-do (KR)

Correspondence Address: MYERS BIGEL SIBLEY & SAJOVEC, PO BOX 37428, RALEIGH, NC, 27627, US

(21) Appl. No.: 10/843,163

(22) Filed: May 11, 2004

(30) Foreign Application Priority Data
May 23, 2003 (KR) 2003-32949

(51) Int. Cl. B66C 23/00

(52) U.S. Cl. 134/157

(57) ABSTRACT

A spin chuck for wafer processing includes: a rotary unit having a top surface adapted to receive and rotate a wafer; a plurality of wafer gripping units mounted on the rotary unit; a set of first gripping members; and a set of second gripping members. Each of the wafer gripping units has at least one of a first gripping member and a second gripping member that are configured to engage a wafer. The wafer gripping units are movable between first and second gripping positions, wherein in the first gripping position, the first gripping members are positioned to engage a wafer received on the rotary unit and the second gripping members are spaced apart from the wafer, and in the second gripping position, the second gripping members are positioned to engage the wafer, and the first gripping members are spaced apart from the wafer.

### RELATED APPLICATION

This application claims the priority of Korean Patent Application No. 10-2003-0032949 filed on May 23, 2003, in the Korean Intellectual Property Office, the disclosure of which is incorporated herein by reference in its entirety.

### BACKGROUND OF THE INVENTION

The present invention relates, in general, to devices for wafer processing and, more particularly, to a rotary device for holding and spinning a wafer, such as a semiconductor wafer or an LCD substrate, during a cleaning process.

In an effort to reduce the production costs of integrated circuit (semiconductor) devices, various research efforts have been directed to simplifying semiconductor production processes. During a conventional semiconductor production process, an edge cleaning procedure may be performed through a plurality of steps, such as a photolithography step, a wet-etching step, and a dry-etching step, to remove particle impurities from a surface and an edge of a semiconductor wafer. In order to simplify the edge cleaning procedure to reduce the production costs of the semiconductor production process, the edge cleaning procedure may be performed using a spin chuck. In this procedure, a patterned or unpatterned wafer may be seated on the spin chuck, and a wafer cleaning solution may be supplied to the surface of the wafer that faces upwardly (i.e., away from the chuck) to remove particle impurities from the surface and the edge of the wafer while the wafer rotates together with the spin chuck.

Unfortunately, the conventional edge cleaning procedure using a spin chuck may be problematic in that, because the spin chuck typically has a plurality of wafer-locking pins and holds a wafer thereon by the use of the wafer-locking pins, particle impurities may not be completely removed from pin-contact areas around the edge of the wafer, but may remain in the pin-contact areas where the edge of the wafer comes into contact with and is engaged by the wafer-locking pins of the spin chuck.

### SUMMARY

The present invention can provide a spin chuck for wafer processing that may allow the edge of the wafer to be effectively cleaned during an edge cleaning procedure. Some embodiments of the inventions are directed to spin chucks for wafer processing. The spin chuck includes: a rotary unit having a top surface adapted to receive and rotate a wafer; a plurality of wafer gripping units mounted on the rotary unit; a set of first gripping members; and a set of second gripping members. Each of the wafer gripping units has at least one of a first gripping member and a second gripping member that are configured to engage a wafer. The wafer gripping units are movable between first and second gripping positions, wherein in the first gripping position, the first gripping members are positioned to engage a wafer received on the rotary unit and the second gripping members are spaced apart from the wafer, and in the second gripping position, the second gripping members are positioned to engage the wafer, and the first gripping members are spaced apart from the wafer. In this configuration, the entirety of the wafer edge may be cleaned, including those areas engaged by the first gripping members.

Other embodiments of the invention are directed to spin chucks for wafer processing including: a rotary unit having a top surface adapted to receive and rotate a wafer; a plurality of wafer-gripping units rotatably mounted on the rotary unit; a first set of gripping members; and a second set of gripping members, wherein each of the wafer gripping units has a first gripping member and a second gripping member that are configured to engage a wafer. The wafer gripping units are rotatable between first and second gripping positions, wherein in the first gripping position, the first gripping members are positioned to engage a wafer received on the rotary unit and the second gripping members are spaced apart from the wafer, and in the second gripping position, the second gripping members are positioned to engage the wafer, and the first gripping members are spaced apart from the wafer.

Further embodiments of the invention are directed to spin chucks for wafer processing that include: a rotary unit having a top surface adapted to receive and rotate a wafer; a plurality of wafer gripping units rotatably mounted on the rotary unit; a set of first gripping members; and a set of second gripping members, wherein each of the wafer gripping units has either a first gripping member or a second gripping member that is configured to engage a wafer. The wafer gripping units are rotatable between first and second gripping positions, wherein in the first gripping position, the first gripping members are positioned to engage a wafer received on the rotary unit and the second gripping members are spaced apart from the wafer, and in the second gripping position, the second gripping members are positioned to engage the wafer, and the first gripping members are spaced apart from the wafer.

For any of the embodiments discussed above, the rotary unit may have a bore that defines a gas path therein to feed a protective gas from a lower portion thereof to the top surface thereof. Also, any of these embodiments may include a guide ring provided between the top surface of the rotary unit and the lower surface of the wafer to guide a wafer cleaning solution to an edge of the downward facing surface of the wafer. In addition, any of these embodiments may have wafer-gripping units that project through the guide ring, with the gripping members projecting upwardly from an upper surface of the guide ring. Moreover, the wafer-gripping units may be rotated around rotating axes thereof at the same time, thus changing the positions of the locking pins concurrently, or

may be sequentially rotated around rotating axes thereof, thus changing the positions of the locking pins one by one. Further, the wafer-gripping units may be arranged along the edge of the top surface of the rotary unit at substantially regular angular intervals.

Still other embodiments of the invention are directed to methods of cleaning a wafer. The method includes: providing a rotary unit with a plurality of wafer gripping units, each of the gripping units having at least one of a first gripping member and a second gripping member; engaging the wafer with a first set of gripping members at a first set of edge locations on the wafer; applying cleaning solution to the wafer; releasing the wafer with the first set of gripping members; engaging the wafer with a second set of gripping members at a second set of edge locations on the wafer that differ from the first set of edge locations; and applying cleaning solution to the wafer to clean the first set of edge locations. In some embodiments, the wafer may be rotating during the cleaning steps.

### BRIEF DESCRIPTION OF THE DRAWINGS

The structure, features and function of the present invention will be more clearly understood from the following detailed description taken in conjunction with the accompanying drawings, in which:

FIG. 1a is a sectional view of a spin chuck for wafer processing, according to embodiments of the present invention;

FIG. 1b is a section view of portion “A” of FIG. 1a;

FIG. 2a is a plan view of the spin chuck for wafer processing of FIGS. 1a and 1b with the wafer gripping units in the first gripping position;

FIG. 2b is a plan view of the spin chuck for wafer processing of FIGS. 1a and 1b with the wafer gripping units in the second gripping position;

FIG. 3 is a partial perspective view of a portion of the spin chuck for wafer processing of FIGS. 1a and 1b that shows a typical wafer-gripping unit of the spin chuck;

FIG. 4a is a sectional view of a spin chuck for wafer processing, according to other embodiments of the present invention;

FIG. 4b is a section view of portion “B” of FIG. 4a;

FIG. 5a is a plan view of the spin chuck for wafer processing of FIGS. 4a and 4b with the wafer gripping units in the first gripping position;

FIG. 5b is a plan view of the spin chuck for wafer processing of FIGS. 4a and 4b with the wafer gripping units in the second gripping position;

FIG. 6 is a partial perspective view of a portion of the spin chuck for wafer processing of FIGS. 4a and 4b that shows a wafer-gripping unit of the spin chuck; and

FIG. 7 is a flow chart illustrating operations of embodiments of the present invention.

### DETAILED DESCRIPTION OF THE INVENTION

The present invention will be described more particularly hereinafter with reference to the accompanying drawings. The invention is not intended to be limited to the illustrated embodiments; rather, these embodiments are intended to fully and completely disclose the invention to those skilled in this art. Like numbers refer to like components throughout, and certain dimensions and thicknesses may be exaggerated for clarity. It will be understood that when an element is referred to as being “attached”, “connected” or “coupled” to another element, it can be directly connected or coupled to the other element or intervening elements may be present. In contrast, when an element is referred to as being “directly attached,” “directly connected” or “directly coupled” to another element, there are no intervening elements present. Further, relative terms, such as “lower” or “bottom” and “upper” or “top,” may be used herein to describe one element's relationship to other elements as illustrated in the figures. It will be understood that relative terms are intended to encompass different orientations of the device in addition to the orientation depicted in the figures. For example, if the device in the figures is inverted, elements described as being on the “lower” side of other elements would then be oriented on “upper” sides of the other elements. The exemplary term “lower” can, therefore, encompass orientations of both “lower” and “upper” depending of the particular orientation of the figure.

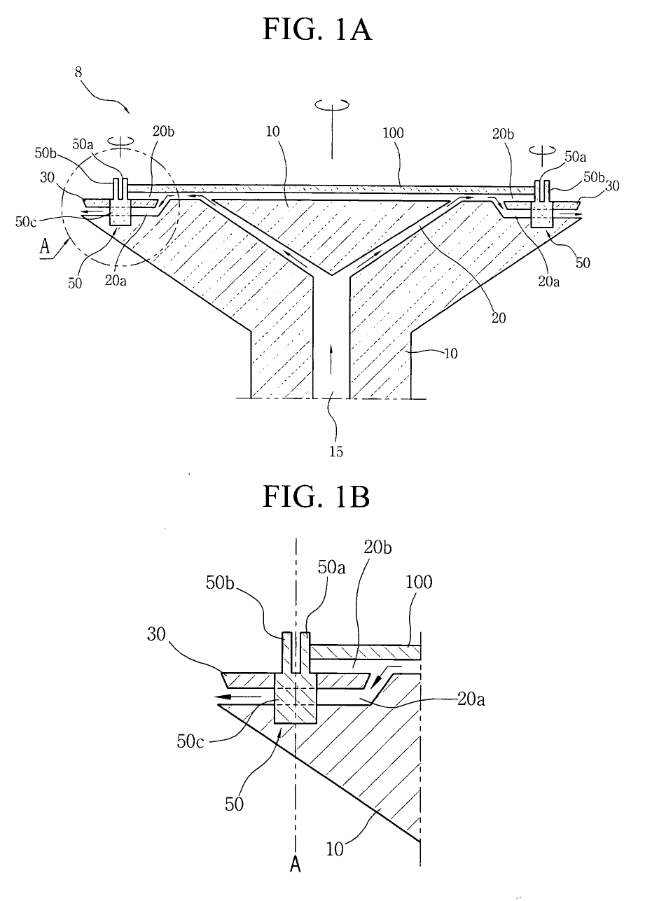

FIG. 1a is a section view of a spin chuck 8 for wafer processing according to certain embodiments of the present invention. As shown in FIG. 1a, the spin chuck 8 has a rotary unit 10, which holds and spins a patterned or unpatterned wafer 100 in a generally horizontal state while an edge cleaning process is performed to clean a surface and an edge of the wafer 100.

If the wafer 100 is a patterned wafer, the wafer 100 may be seated on the rotary unit 10 such that the patterned top surface of the wafer 100 faces downwardly (i.e., toward the spin chuck 8). While the wafer 100 rotates along with the rotary unit 10, a wafer cleaning solution is supplied to the back surface of the wafer 100 as it faces upwardly. Particle impurities may be removed thusly from the back surface and the edge of the patterned wafer 100. When cleaning a patterned wafer 100 with the spin chuck 8, it is typically desirable to prevent the wafer cleaning solution from reaching the patterned surface of the wafer 100 as it faces downwardly. When an unpatterned wafer, which typically must be cleaned on both surfaces thereof, is cleaned by the use of the spin chuck 8, typically the wafer 100 is turned upside down on the spin chuck 8 after one surface of the wafer 100 is completely cleaned. In such a case, it may be necessary to prevent the wafer cleaning solution from undesirably affecting the just-cleaned surface of the unpatterned wafer as it faces downwardly. A protective gas, such as nitrogen gas, is thus supplied to the downwardly-facing surface of a patterned or unpatterned wafer 100 so as to prevent the wafer cleaning solution from flowing to and negatively affecting the downwardly-facing surface of the wafer 100.

Referring still to FIG. 1a, to supply such protective gas, the rotary unit 10 is configured to include a hollow bore 15 (typically cylindrical in shape) at a lower portion thereof. The bore 15 defines a gas path in the lower portion to receive the protective gas, such as nitrogen gas, from an external gas source. A gas-discharging path 20 is formed in an upper portion of the rotary unit 10 so as to communicate with the bore 15 and with the lower surface of the wafer 100. As a result, the protective gas may be discharged upwardly to the downwardly-facing surface of the wafer 100.

Referring again to FIG. 1a and also to FIG. 1b, a guide ring 30 is securely installed along an edge of a top surface of the rotary unit 10 so as to be positioned between the edge of the top surface of the rotary unit 10 and the edge of the lower surface of the wafer 100. In this position, the guide ring 30 can guide the wafer cleaning solution from the edge of the downward facing surface of the wafer 100 during the edge cleaning process. The guide ring 30 may be slightly spaced upwardly apart from the edge of the top surface of the rotary unit 10 to form a first gap 20a, as best seen in FIG. 1b. In addition, due to the pressure of the protective gas that is discharged upward from the gas-discharging path 20 of the rotary unit 10 during the edge cleaning process, the wafer 100 may be slightly spaced upward apart from an upper surface of the guide ring 30 to form a second gap 20b.

The protective gas which is discharged upwardly from the gas-discharging path 20 of the rotary unit 10 during the edge cleaning process flows radially outward through the first gap 20a to be discharged to the external environment of the rotary unit 10 as shown in FIGS. 1a and 1b. When such flow is occurring, the pressure in the second gap 20b may be reduced (due to the principles defined in Bernoulli's theorem), which can cause the wafer cleaning solution to flow from the upper surface of the wafer 100 into the second gap 20b between the wafer 100 and the guide ring 30. The wafer cleaning solution that is guided into the second gap 20b may be discharged to the external environment of the rotary unit 10 through the first gap 20a together with the protective gas. During the edge cleaning procedure, the area around the edge of the downwardly-facing surface of the wafer 100, which is to be in contact with and cleaned by the wafer cleaning solution, may be controlled, as desired, by adjusting the position of the guide ring 30 relative to the wafer 100.

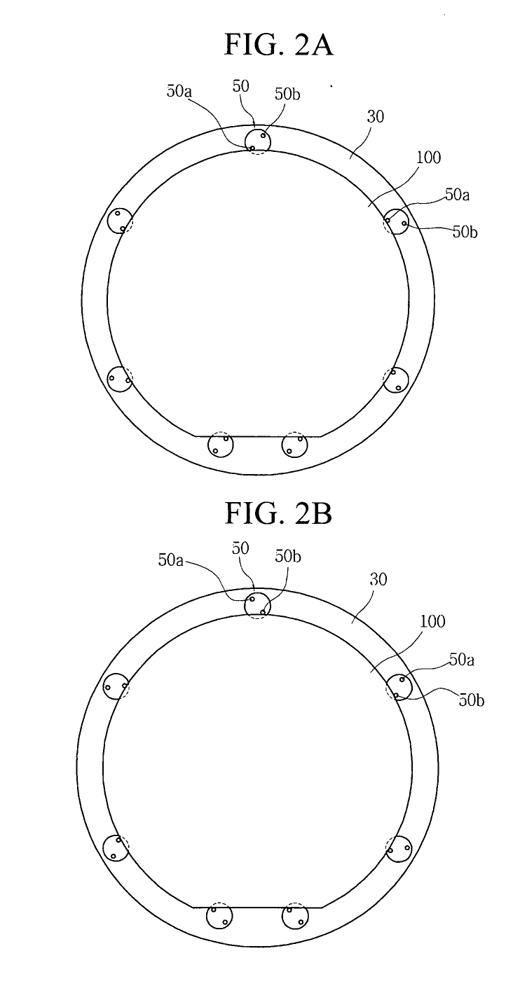

Referring yet again to FIGS. 1a and 1b and also to FIG. 2a, in order to prevent the wafer 100 from being undesirably removed from the spin chuck 8 during the edge cleaning procedure, a plurality of wafer-gripping units 50 are arranged along the edge of the top surface of the rotary unit 10. In the illustrated embodiments, each of the wafer-gripping units 50 comprises a rotary body 50c, with a plurality of locking pins 50a, 50b projecting upwardly from an upper surface of the rotary body 50c of each wafer-locking unit 50 to hold the edge of the wafer 100. In these embodiments, first and second locking pins 50a, 50b are provided at the upper surface of the rotary body 50c of each wafer-locking unit 50.

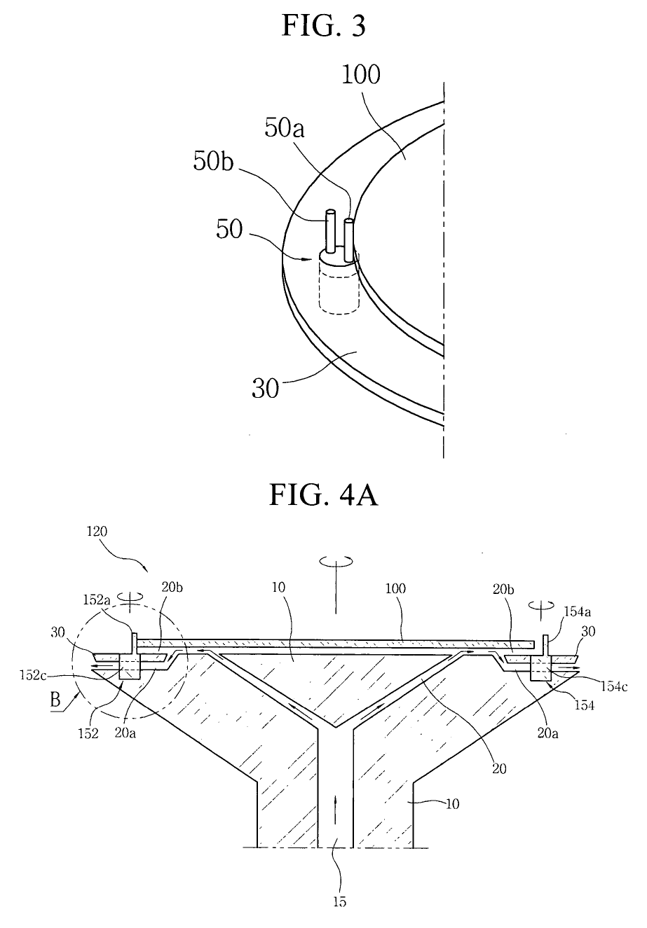

As shown in FIG. 3, the rotary body 50c of each wafer-locking unit 50 may extend upwardly through the guide ring 30, with the two locking pins 50a, 50b projecting upwardly from the upper surface of the rotary body 50c. The lower portion of the rotary body 50c of the wafer-locking unit 50 is rotatably mounted onto the top surface of the rotary unit 10 for rotation about an axis of rotation A.

In order to hold the edge of the wafer 100 on the rotary unit 10, prior to starting the edge cleaning process, the rotary body 50c of each wafer-locking unit 50 rotates about its axis of rotation A to a first gripping position in which one of the two locking pins 50a, 50b, for example, the first locking pin 50a, comes into contact with and engages the edge of the wafer 100 (see FIG. 2a). After the edge of the wafer 100 is engaged by the first locking pins 50a of the wafer-locking units 50, the edge cleaning procedure is started to clean the wafer 100 as described above. As shown in the illustrated embodiments, the locking pins 50a, 50b may be arranged along an edge of the upper surface of the rotary body 50c of each wafer-gripping unit 50 at regular angular intervals (.e., in this instance, diametrically opposed from one another across the rotary body 50c).

In an effort to reduce the risk of the first locking pins 50a from damaging the edge of the wafer 100 when engaging the wafer 100, the locking pins 50a may be formed of a material with chemical inertness, a high heat resistance, and/or a low friction coefficient. An example of such a material is TEFLON® PTFE resin.

When it is desired to clean the pin-contact areas (.i.e., those areas of the wafer 100 covered when the first locking pin 50a has come into contact with the edge of the wafer 100 to engage the wafer 100 during the edge cleaning procedure), the rotary body 50c of each wafer-gripping unit 50 rotates about its axis of rotation A to a second gripping position in which the second locking pin 50b comes into contact with and engages the edge of the wafer 100, in place of the first locking pin 50a, as shown in FIG. 2b. Therefore, it may be possible to clean the pin-contact areas of the wafer 100, where the edge of the wafer 100 has been held and covered by the first locking pins 50a.

In order to change the positions of the locking pins 50a, 50b so as to allow the second locking pins 50b to replace the first locking pins 50a to engage the edge of the wafer 100, the wafer-gripping units 50 may rotate at the same time to concurrently change the positions of the locking pins 50a, 50b or may sequentially rotate to change the positions of the locking pins 50a, 50b one by one. In order to reduce the risk of the wafer 100 from being undesirably removed from the rotary unit 10 when the positions of the locking pins 50a, 50b are changed concurrently, the process of changing the pin positions may be performed after the rotation of the wafer 100 is stopped.

In some embodiments, three or more wafer-gripping units 50 may be employed on the rotary unit 10 in order to stably hold the wafer 100. In addition, the wafer-gripping units 50 may be arranged along the periphery of the rotary unit 10 at substantially regular angular intervals, thus which may engage the wafer 100 with generally equal pressure.

Those skilled in this art will recognize that other configurations of the spin chuck 8 may also be suitable for use with the present invention. For example, the locking pins 50a, 50b need not be pins; any type of gripping member, such as a post, column, clip, finger, hook, or the like, of virtually any shape that can engage a wafer, may be employed. Also, the wafer gripping units are shown as rotating between the first and second gripping positions, but other techniques and configurations for engaging and releasing the wafer with gripping members may be employed. For example, a wafer gripping unit may include two gripping members that “toggle” back and forth, or that rise from the guide ring, to engage and disengage the wafer). The ordinarily skilled artisan will recognize other suitable configurations.

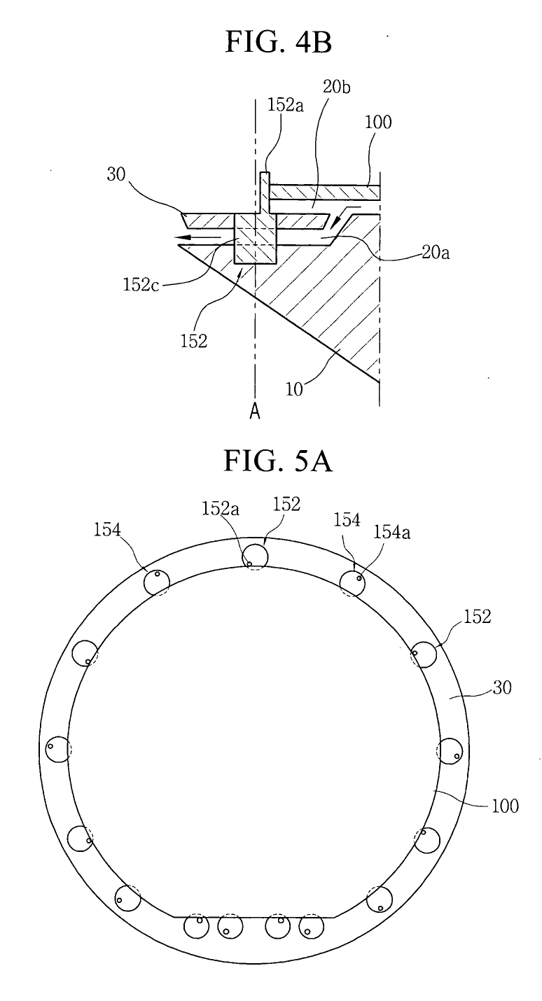

FIG. 4a is a section view of a spin chuck 120 for wafer processing according to other embodiments of the present invention. FIG. 4b is a section view of inset “B” of FIG. 4a. Many of the components of embodiments of FIGS. 4a-6 are common with those of embodiments of FIGS. 1a-3. Those components common to all of these embodiments will thus carry the same reference numerals, and a further explanation of these components need not be included herein.

As shown in FIGS. 4a and 4b, the spin chuck 120 comprises a plurality of first and second wafer-gripping units 152 and 154 which are arranged along the edge of a top surface of a rotary unit 10. The first and second wafer-gripping units 152 and 154 thus engage the edge of a wafer 100 while reducing the risk of the wafer 100 from being undesirably removed from the spin chuck 120 during an edge cleaning process.

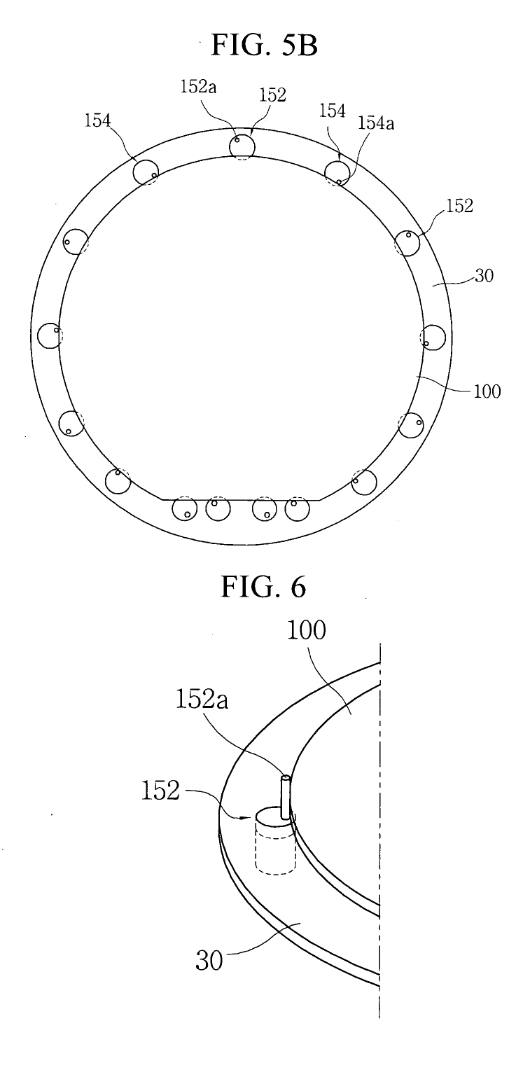

The first wafer-gripping units 152 each comprise a rotary body 152c, with a locking pin 152a projecting upwardly from an upper surface of the rotary body 152c, as shown in FIGS. 5a, 5b and 6. The second wafer-gripping units 154 each comprise a rotary body 154c, with a locking pin 154a projecting upwardly from an upper surface of the rotary body 154c.

As shown in FIGS. 5a and 5b, the first and second wafer-locking units 152 and 154 alternately hold the edge of the wafer 100 during the edge cleaning process. That is, the edge cleaning process may be started, with the pins 152a of the first wafer-locking units 152 holding the edge of the wafer 100 on the rotary unit 10 in the first gripping position (FIG. 5a). When it is desired to clean the pin-contact areas at which the pins 152a of the first wafer-locking units 152 have come into contact with the edge of the wafer 100 to engage the wafer 100, the rotary bodies 154c of the second wafer-locking units 154 rotate simultaneously or sequentially so as to hold the edge of the wafer 100 by the pins 154a thereof in the second gripping position (FIG. 5b). After the locking pins 154a of the second wafer-gripping units 154 engage the edge of the wafer 100, the rotary bodies 152c of the first wafer-gripping units 152 rotate concurrently or sequentially so as to space the pins 152a thereof apart from the edge of the wafer 100. Therefore, it is possible to clean the pin-contact areas of the wafer 100, where the edge of the wafer 100 has been held and covered by the pins 152a of the first wafer-locking units 152.

In these embodiments of the present invention, there may be three or more of each of the first and second wafer-locking units 152 and 154. The first wafer-locking units 152 and the second wafer-locking units 154 may be alternately arranged on the rotary unit 10 in order to stably hold the wafer 100. In addition, the first and second wafer-locking units 152 and 154 may be arranged along the edge of the wafer 100 at substantially regular angular intervals in order to hold the wafer 100 with generally equal amounts of pressure.

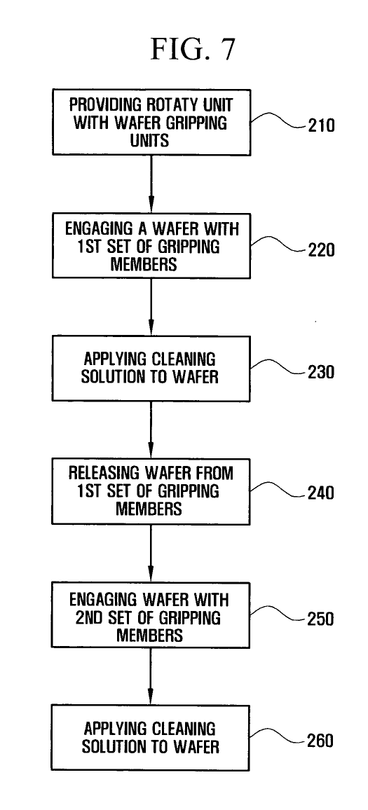

Referring now to FIG. 7, methods of cleaning a wafer according to certain embodiments of the present invention are illustrated. A spin chuck such any of those described herein is provided (Block 210). A wafer is engaged with a first set of gripping members (Block 220), and cleaning solution is applied to the gripped wafer (Block 230). The wafer is released from the first set of gripping members (Block 240) and engaged with the second set of gripping members (Block 250). Cleaning solution is then applied to the wafer, which can enable the cleaning of edge locations that were covered by the first set of gripping members (Block 260). In some embodiments, the wafer is rotated during the application of cleaning solution.

As described above, the present invention provides a spin chuck for wafer processing, which has a plurality of wafer-locking units capable of holding a wafer by locking pins thereof during an edge cleaning process, while allowing the pin-contact areas of the edge of the wafer to be effectively cleaned during the edge cleaning process. Therefore, the spin chuck may effectively remove contaminants from wafers that may otherwise reduce work efficiency in post-processes of the semiconductor producing process.

Although certain embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A spin chuck for wafer processing, comprising:
a rotary unit having a top surface adapted to receive and rotate a wafer; and
a plurality of wafer gripping units mounted on the rotary unit;
a set of first gripping members; and
a set of second gripping members;
each of the wafer gripping units having at least one of a first gripping member and a second gripping member, the first and second gripping members being configured to engage a wafer, the wafer gripping units being movable between first and second gripping positions, wherein in the first gripping position, the first gripping members are positioned to engage a wafer received on the rotary unit and the second gripping members are spaced apart from the wafer, and in the second gripping position, the second gripping members are positioned to engage the wafer, and the first gripping members are spaced apart from the wafer.

2. The spin chuck according to claim 1, wherein each of the wafer gripping units is rotatably mounted on the rotary unit and is rotatable between the first and second gripping positions.

3. The spin chuck according to claim 2, wherein each of the wafer-gripping units has a rotary body, and wherein the first and second gripping members comprise locking pins projecting upward from an upper surface of the rotary body to hold the wafer.

4. The spin chuck according to claim 2, wherein the wafer-gripping units are rotated around rotational axes thereof concurrently, thus rotating each of the first and second gripping members between the first and second positions concurrently.

5. The spin chuck according to claim 2, wherein the wafer-gripping units are sequentially rotated around rotational axes thereof, thus rotating each of the first and second gripping members between the first and second positions sequentially.

6. The spin chuck according to claim 1, wherein the rotary unit has a bore that defines a gas path therein to feed a protective gas from a lower portion thereof to the top surface thereof.

7. The spin chuck according to claim 1, further comprising a guide ring mounted above the top surface of the rotary unit and configured to guide a wafer cleaning solution to an edge of the downwardly facing surface of the wafer.

8. The spin chuck according to claim 6, wherein each of the wafer-gripping units projects through the guide ring, with the first and second gripping members projecting upward from an upper surface of the guide ring.

9. The spin chuck according to claim 1, wherein the wafer-gripping units are arranged around the periphery of the rotary unit at substantially regular angular intervals.

10. The spin chuck according to claim 1, wherein ones of the wafer gripping units have both a first gripping member and a second gripping member.

11. The spin chuck according to claim 1, wherein one set of wafer gripping units includes first gripping members, and another set of wafer gripping units includes second gripping members.

12. A spin chuck for wafer processing, comprising:
a rotary unit having a top surface adapted to receive and rotate a wafer; and
a plurality of wafer gripping units rotatably mounted on the rotary unit;
a set of first gripping members; and
a set of second gripping members;
each of the wafer gripping units having a first gripping member and a second gripping member, the first and second gripping members being configured to engage a wafer, the wafer gripping units being rotatable between first and second gripping positions, wherein in the first gripping position, the first gripping members are positioned to engage a wafer received on the rotary unit and the second gripping members are spaced apart from the wafer, and in the second gripping position, the second gripping members are positioned to engage the wafer, and the first gripping members are spaced apart from the wafer.

13. The spin chuck according to claim 12, wherein each of the wafer-gripping units has a rotary body, and wherein the first and second gripping members comprise locking pins projecting upwardly from an upper surface of the rotary body to hold the wafer.

14. The spin chuck according to claim 12, wherein the wafer-gripping units are rotated around rotating axes thereof concurrently, thus rotating each of the first and second gripping members between the first and second positions concurrently.

15. The spin chuck according to claim 12, wherein the wafer-gripping units are sequentially rotated around rotational axes thereof, thus rotating each of the first and second gripping members between the first and second positions sequentially.

16. The spin chuck according to claim 12, wherein the rotary unit has a bore that defines a gas path therein to feed a protective gas from a lower portion thereof to the top surface thereof.

17. The spin chuck according to claim 12, further comprising a guide ring mounted above the top surface of the rotary unit and configured to guide a wafer cleaning solution to an edge of the downwardly facing surface of the wafer.

18. The spin chuck according to claim 17, wherein each of the wafer-gripping units projects through the guide ring, with the first and second gripping members projecting upward from an upper surface of the guide ring.

19. The spin chuck according to claim 12, wherein the wafer-gripping units are arranged around the periphery of the rotary unit at substantially regular angular intervals.

20. A spin chuck for wafer processing, comprising:
a rotary unit having a top surface adapted to receive and rotate a wafer; and
a plurality of wafer gripping units rotatably mounted on the rotary unit;
a set of first gripping members; and
a set of second gripping members;
each of the wafer gripping units having either a first gripping member or a second gripping member, the first and second gripping members being configured to engage a wafer, the wafer gripping units being rotatable between first and second gripping positions, wherein in the first gripping position, the first gripping members are positioned to engage a wafer received on the rotary unit and the second gripping members are spaced apart from the wafer, and in the second gripping position, the second gripping members are positioned to engage the wafer, and the first gripping members are spaced apart from the wafer.

21. The spin chuck according to claim 20, wherein each of the wafer-gripping units has a rotary body, and wherein the first and second gripping members comprise locking pins projecting upwardly from an upper surface of the rotary body to hold the wafer.

22. The spin chuck according to claim 20, wherein the wafer-gripping units are rotated around rotating axes thereof concurrently, thus rotating each of the first and second gripping members between the first and second positions concurrently.

23. The spin chuck according to claim 20, wherein the wafer-gripping units are sequentially rotated around rotational axes thereof, thus rotating each of the first and second gripping members between the first and second positions sequentially.

24. The spin chuck according to claim 20, wherein the rotary unit has a bore that defines a gas path therein to feed a protective gas from a lower portion thereof to the top surface thereof.

25. The spin chuck according to claim 20, further comprising a guide ring mounted above the top surface of the rotary unit and configured to guide a wafer cleaning solution to an edge of the downwardly facing surface of the wafer.

26. The spin chuck according to claim 25, wherein each of the wafer-gripping units projects through the guide ring, with the first and second gripping members projecting upward from an upper surface of the guide ring.

27. The spin chuck according to claim 20, wherein the wafer-gripping units are arranged around the periphery of the rotary unit at substantially regular angular intervals.

28. A method of cleaning a wafer, comprising:
providing a rotary unit with a plurality of wafer gripping units, each of the gripping units having at least one of a first gripping member and a second gripping member;
engaging the wafer with a first set of gripping members at a first set of edge locations on the wafer;
applying cleaning solution to the engaged wafer;
releasing the wafer with the first set of gripping members;
engaging the wafer with a second set of gripping members at a second set of edge locations on the wafer that differ from the first set of edge locations; and
applying cleaning solution to the engaged wafer to clean the first set of edge locations.

29. The method defined in claim 28, further comprising:
rotating the wafer rotating as it is gripped with the first set of gripping members and during the step of applying a cleaning solution; and
rotating the wafer as it is gripped with the second set of gripping members and during the step of applying cleaning solution to the wafer to clean the first set of edge locations;

30. The method according to claim 28, wherein each of the wafer gripping units has both a first gripping member and a second gripping member.

31. The method according to claim 28, wherein one set of wafer gripping units includes first gripping members, and another set of wafer gripping units includes second gripping members.

32. The method according to claim 28, wherein each of the wafer gripping units is rotatably mounted on the rotary unit.

33. The method according to claim 32, wherein releasing the wafers comprises rotating the wafer gripping units such that the first gripping members lose contact with the edge of the wafer.

34. The method according to claim 33, wherein rotating the wafer gripping units comprises rotating all of the wafer gripping units that include first gripping members concurrently.

35. The method according to claim 33, wherein rotating the wafer gripping units comprises rotating all of the wafer gripping units that include first gripping members sequentially.
